(19) United States
(12) Patent Application Publication
(10) Pub. No.: US 2016/0229723 A1
(43) Pub. Date: Aug. 11, 2016

(54) CHEMICAL FORMULATION AND METHOD FOR THE REMEDIATION AND SANITIZATION OF OIL AND PETROLEUM CONTAINING WASTEWATER

(71) Applicant: AVMOR LTD., Laval (CA)

(72) Inventor: Eric Olivier, Montreal (CA)

(73) Assignee: Avmor LTD, Laval (CA)

(21) Appl. No.: 15/024,097

(22) PCT Filed: Sep. 16, 2014
(86) PCT No.: PCT/CA2014/050880

§ 371 Date: Mar. 23, 2016

Related U.S. Application Data
(60) Provisional application No. 61/881,260, filed on Sep. 23, 2013.

(51) Int. Cl. C02F 1/72; C02F 1/76; C02F 1/52

(52) U.S. Cl. CPC C02F 1/722; C02F 1/5236; C02F 1/76; C02F 2101/32

(57) ABSTRACT

The present disclosure relates to the remediation of oil containing wastewater, particularly wastewater containing petroleum and crude oil from industrial extractions and manipulations, spill and vehicle contamination. Particularly, it is disclosed a composition comprising a sanitizer and a dispersing agent for the clearing of the water phases. The composition can further comprise a precipitation agent, to break emulsion and separate the organic layer from the wastewater for isolation.

### TECHNICAL FIELD

The present description relates to a composition for treating wastewater comprising a water soluble sanitizer and a dispersing/emulsifier agent.

### BACKGROUND ART

Wastewater containing petroleum and crude oil from industrial extractions and manipulations, spill and vehicle contamination are of significant importance and is increasingly regulated. The remediation of such waste water is capital for the continued and sustainable use of this resource. Decontamination of the wastewater involves the reduction of chemicals solubilized in water, the reduction of the chemical toxicity and the elimination of pathogenic bacterial contaminants like E. coli bacteria found in settling ponds, vehicle wash water reservoirs, oil containing sewage and sludge. Much attention has been devoted to the treatment of wastewater in many industries, but specific and systematic approaches known to this date for treating wastewater from oil soils have limited success. The need for better technologies for water remediation specifically targeting oil sands, oil spills, and vehicle wash wastewater is of important environmental concern.

Generally, the wastewaters from large-scale industries such as oil refineries, petrochemical plants, and natural gas processing plants commonly contain gross amounts of oil and suspended solids. Those industries use a device known as an API oil-water separator which is designed to separate the oil and suspended solids from their wastewater effluents.

The API separator is a gravity separation device based on the specific gravity difference between the oil, the water and the suspended solids. The suspended solids settles to the bottom of the separator as a sediment layer, the oil rises to top of the separator and the cleansed wastewater is the middle layer between the oil layer and the solids.

Typically, the oil layer is skimmed off and subsequently re-processed or disposed of, and the bottom sediment layer is removed by a chain and flight scraper (or similar device) and a sludge pump. The water layer is sent to further treatment for additional removal of any residual oil and then to some type of biological treatment unit for removal of undesirable dissolved chemical compounds.

Tailing ponds are also used as a settling basin/storage container for the mixture of water, sand, clay and residual oil that is left over after oil sands processing. Once in the pond, the sand quickly sinks to the bottom, and the water from the top section is recycled. Tailing ponds present multiple challenges such as the risk of seepage into ground water, long time of settling of the mixture of clay and water at the bottom of the pond, concentrations of natural chemicals that are toxic to fish and other animal in the water that came into contact with oil during the extraction process, and small amount of residual oil that floats to the surface of the pond poses a risk to waterfowl. It takes approximately 30-40 years before being able to reclaim a tailing pond to a self-sustain ecosystem.

Oil sands are generally composed of complex organic molecules like alkanes, paraffin, kerosene, olefins, naphthalene, xylene and aromatics. Oil sands also contain sulfur containing molecules like hydrogen sulfide. Solid matter in oil sands is generally composed of sand and clay (small silicate particles). Oil sands also contain metals like nickel and vanadium. It is very difficult to remove this complex and sticky mixture from accumulation on equipment and vehicle used, and the wastewater stagnation favors the rapid development of E. coli bacteria, levels of which a regularly monitored in modern operations.

One technique for treating wastewater that has been described is oxidative remediation. Canadian patent application no. 2,752,423 describes a method of treating aqueous streams derived from oils sands operations in order to eliminate odor coming from the treated streams. The method consists in using an oxidizer and more particularly, hydrogen peroxide, to oxidize the H₂S, limiting H₂S emission causing the odor.

While there has been much attention devoted to the treatment of wastewater derived from various industries and more particularly in the oil industry, there is still a need to be provided with methods and formulations to improve treatment of wastewater, particularly wastewater containing petroleum and crude oil.

### SUMMARY

In accordance with the present disclosure there is now provided a composition for remediation of wastewater comprising a water soluble sanitizer; and a dispersing/emulsifier agent.

In accordance to another embodiment, it is also provided a composition for remediation of wastewater comprising hydrogen peroxide and polyaspartic acid; hydrogen peroxide and polyacrylic acid; potassium permanganate and polyaspartic acid; or hydrogen peroxide and polyethylene glycol.

In accordance to another embodiment, it is also provided a method for remediation of wastewater of contaminants comprising the step of adding a composition comprising a water soluble sanitizer and a dispersing/emulsifier agent to the wastewater to be remediated, producing remediated water removed of contaminants.

In accordance to another embodiment, it is also provided a method of manufacturing a composition for remediation of wastewater comprising mixing a water soluble sanitizer and a dispersing/emulsifier agent.

In an embodiment, the water soluble sanitizer is an oxidizer.

In an embodiment, wherein the oxidizer comprises a fluorine, a hydroxyl radical, a sulfate radical, a persulfate anion, hydrogen peroxide, a permanganate, a peroxysulfuric acid, ozone, hypochlorite, chlorine dioxide an organic peracid, a polymeric peracid, a polymeric peracid derived from polyaspartic acid or a combination thereof.

In an embodiment, the water soluble sanitizer is an organic peracid.

In another embodiment, the water soluble sanitizer is a polymeric peracid.

In another embodiment, the water soluble sanitizer is a polymeric peracid derived from polyaspartic acid.

In another embodiment, the water soluble sanitizer is hydrogen peroxide.

In a further embodiment, the dispersing/emulsifier agent is polypropylene glycol, polyethylene glycol, polyaspartic acid, polyethylenimine, polyacrylic acid, or a combination thereof.

In an embodiment, the composition comprises between 2-70% of water soluble sanitizer and between 5-70% of dispersing/emulsifier agent.

In an embodiment, the composition comprises 25% hydrogen peroxide and 2% polyaspartic acid, 25% hydrogen peroxide and 4% sodium polyaspartate; 25% hydrogen peroxide and 20% polyethylene glycol; 5% hydrogen peroxide and 2% polyaspartic acid; 20% hydrogen peroxide and 2% polyaspartic acid; 25% hydrogen peroxide and 0.5% polyaspartic acid; 25% hydrogen peroxide and 5% polyaspartic acid; 25% hydrogen peroxide and 10% polyaspartic acid; 25% hydrogen peroxide and 25% polyaspartic acid; 25% hydrogen peroxide and 50% polyaspartic acid; 30% hydrogen peroxide and 30% polyaspartic acid; 50% hydrogen peroxide and 30% polyaspartic acid; 70% hydrogen peroxide and 10% polyaspartic acid; 70% hydrogen peroxide and 10% polyacrylic acid; 70% hydrogen peroxide and 10% polyethylene glycol; 24% of hydrogen peroxide and 5% polyaspartic acid; or 70% permanganate and 10% polyacrylic acid.

In another embodiment, the dispersing/emulsifier agent as a suitable pH lower than 7.

In a supplemental embodiment, the pH of the dispersing/emulsifier agent is lower than 5.

In another embodiment, the pH of the dispersing/emulsifier agent is 4.

In another embodiment, it is encompassed the addition of a settling and precipitation agent.

In an embodiment, the settling and precipitation agent is calcium chloride, magnesium oxide or sodium chloride.

In another embodiment, the composition comprises calcium chloride, particularly at least 5% calcium chloride, alternatively 10% calcium chloride.

In an embodiment, the wastewater comprises organic molecules, sulfur containing molecules, solid matter, metals, pathogenic bacterial contaminants, or a combination thereof.

In an embodiment, the organic molecules are alkanes, paraffin, kerosene, olefins, naphthalene, xylene and aromatics molecules.

In another embodiment, the sulfur containing molecules are hydrogen sulfide.

In an alternative embodiment, the solid matter is sand, clay, or a combination thereof.

In another embodiment, the metals are nickel or vanadium.

In another embodiment, the pathogenic bacterial contaminants are E. coli bacteria.

### BRIEF DESCRIPTION OF THE DRAWINGS

FIG. 1 shows photos of samples of examples of formulations as described herein for the remediation and sanitization of wastewater.

FIG. 2 shows a picture of treated sump water with an example of the formulation described herein (transparent vial) compared to untreated sump water.

### DETAILED DESCRIPTION

It is provided a method and formulation for the remediation and sanitization of wastewater.

Remediation of the oil containing wastewater is effectively achieved using a blend of chemicals that sanitize, detoxify and deodorize. Particularly, it is disclosed a composition comprising a sanitizer and a dispersing agent for the clearing of the water phases. If the wastewater also contains significant surfactants from vehicle wash for example, the composition further comprises a precipitation agent, to break emulsion and separate the organic layer from the wastewater for isolation.

Accordingly, it is disclosed a composition comprising:

a water soluble sanitizer; and

a dispersing/emulsifier agent.

In an embodiment, the water soluble sanitizer is an oxidizer. The oxidizer produces reactive radicals that allow For example, the oxidizer can comprise a fluorine, a hydroxyl radical, a sulfate radical, a persulfate anion, hydrogen peroxide, a permanganate, a peroxysulfuric acid, ozone, hypochlorite, chlorine dioxide, an organic peracid, a polymeric peracid, a polymeric peracid derived from polyaspartic acid or a combination thereof. Encompassed herein as dispersing/emulsifier agents are for example polypropylene glycol, polyaspartic acid, polyethylenimine (or polyaziridine), polyacrylic acid, or a combination thereof, at a suitable pH (lower than 7 preferably lower than 5).

The dispersing/emulsifier agents encompassed can have varying chain length and molecular weight.

The combination of an oxidizer such as hydrogen peroxide with a dispersing/emulsifier agent such polyaspartate allows the formation of polymeric peracids which increase the efficacy of clarification and remediation properties of the composition described herein.

The composition described herein can comprise further settling and precipitation agent. The settling and precipitation agent can for example comprise calcium ions, such as calcium chloride, magnesium oxide or sodium chloride. The settling and precipitation agent helps precipitating surfactants present in the wastewater. Solubility of calcium chloride for example when present in water reduces the total amount of undesirable soluble material present in the water by competition effect. The addition of a settling and precipitation agent will have a salting out effect when necessary to reduce the amount of soluble organic material present in water. The increase in salt concentration will force water molecules to be attracted by the salt ions. The number of water molecules available to interact with the charged part of the surfactants or other undesirable soluble material decreases.

Oil sands derived wastewaters present particular remediation challenges due to their complex chemical nature. For example, the composition of the oil sands derived water will vary depending on the type of oil sands operation from which the water is derived. Therefore, even water derived from different sources within the oil sands operations may present unique remediation issues relating to that particular source or a combination of sources. For example, the produced water tank in oil sands operations may receive a combination of water influents having different contaminants, different pH, temperature, which individually or synergistically may have different downstream impacts. Wastewaters derived from oil sands operations comprise a contaminant profile which may include, for example, oil, odor causing species, non-sulfur organic species, organo-sulfur species, organometallic species, and inorganic species or a combination thereof which may be dissolved, dispersed or bound within suspended solid material that may be present in the oil sands derived aqueous streams depending on the source. Furthermore, the oil sands wastewaters may comprise emulsions (e.g., hydrocarbon in water emulsions) which may further complicate the remediation process for such water. For example, the produced water derived from oil sands operations may have a high silica content, hydrogen sulfide, water soluble organics and oil from bitumen, hardness causing species, as well as have a high temperature.

The method and the composition disclosed herein are used for the remediation of water streams from oil sands operations and oil containing wastewater. Treatment of the wastewater is achieved via the addition of the present solution, preferably without the need for agitation. The disclosed solution can also be used to treat wastewater from oil sands hot water process, oil sands equipment and vehicle and water phases from oil spill.

In an embodiment, it is provided the use of an aqueous solution containing hydrogen peroxide as the sanitizer and polyaspartic acid at a suitable pH (preferably 3 to 5) as the dispersing agent for the sanitization of wastewater from the washing of vehicle, eliminating bacteria and toxic hydrogen sulfide. Wastewater solutions from vehicle wash also become dark black with time and this method rapidly discolors the wastewater to a clear uncolored solution. Also, the settling of the small silicate particles to a pale deposit is somewhat made more rapidly and efficiently, leading to a clear water within 1 week of dispersion of the solution. Hydrogen peroxide is effectively destroyed in this process of sanitisation and oxidation, and oxygen is produced. Polyaspartic acid is a natural polymer that is biodegraded rapidly in the environment thus not accumulating in the wastewater streams. The rapid settling of the silicate particles may be associated with the action of peroxide functionalized molecules hydrogen peroxide on the silicate particles, thus separating the particles from their organic coating and reducing their buoyancy.

Another aspect disclosed herein is the use of a solution containing hydrogen peroxide, polyethylene glycol and calcium chloride for the remediation of wastewater from oil spill cleanup operations where slurries of oil, organic waste from sewage and sediments from city sewers, streams, rivers, ponds or lakes can be found. The addition of this solution will sanitize, detoxify and clear up water through breakdown of emulsions of organic compounds.

The composition disclosed herewith is especially suitable where surfactant products where used in the cleanup operations helping to separate organic layer of oil spill products from the wastewater.

The method and composition described herein present many advantages. Wastewater is effectively reduced following the methodology described and it can be reused for larger amounts of cleaning. The reduction in the smell and dispersion/separation of sludge and organic matter increases the quality of the water. The eliminations of pathogens like E. coli bacteria reduce the health risk to the operators exposed to such wastewater. When proper amounts are used in the spill cleanup, more water may be reintroduced in the environment due to lower toxicity.

Large vehicle washing in city environments also need to remediate wastewater issues by the reduction of oils and greases in the wastewater traps used to collect and separate organics from the water phase in the cleaning operations. City buses, trains, subways and maintenance vehicles all accumulate oils and greases that are washed off and create large amounts of wastewater. Large and small vehicles in mines, oil sands mines and sewage plants all generate significant amounts of oil containing wastewater that accumulate and build up bacterial counts.

Remediation of wastewater from vehicle washing using high volumes of surfactant is enhanced by the addition of a solution of hydrogen peroxide comprising an emulsion breaker like polyethylene glycol, polyacrylic acid and/or other organic de-emulsifiers and the addition of calcium chloride.

In another example due to the different nature of the oil containing contaminants, a solution of hydrogen peroxide containing a dispersion agent like polyaspartic acid is better suited for the remediation of the wastewater. Also, reuse of this water for further cleaning of vehicles benefits from the rust inhibitor properties of the polyaspartic acid component.

By adding the formulation described herein, the fecal coliforms and other microbes can be eliminated by approx. 99.99% (or greater) while eliminating organic matter, therefore, clearing up the water (visually) to expedite the sedimentation processes.

The present disclosure will be more readily understood by referring to the following examples which are given to illustrate embodiments rather than to limit its scope.

### Example I

### Preparation of Composition for Treating Wastewater

The following samples have been prepared

| Samples | Sanitizer | Dispersing/emulsifier agent |
|---|---|---|
| 1 | polyaspartic acid 2% | hydrogen peroxide 5% |
| 2 | polyaspartic acid 2% | hydrogen peroxide 20% |
| 3 | polyaspartic acid 0.5% | hydrogen peroxide 25% |
| 4 | polyaspartic acid 5% | hydrogen peroxide 25% |
| 5 | polyaspartic acid 10% | hydrogen peroxide 25% |
| 6 | polyaspartic acid 25% | hydrogen peroxide 25% |
| 7 | polyaspartic acid 50% | hydrogen peroxide 25% |
| 8 | polyaspartic acid 30% | hydrogen peroxide 30% |
| 9 | polyaspartic acid 30% | hydrogen peroxide 50% |
| 10 | polyaspartic acid 10% | hydrogen peroxide 70% |
| 11 | polyacrylic acid 10% | hydrogen peroxide 70% |
| 12 | polypropylene glycol 10% | hydrogen peroxide 70% |
| 13 | polyaspartic acid 10% | potassium permanganate 70% |
| 14 | polyaspartic acid 10% | hydrogen peroxide 70% |

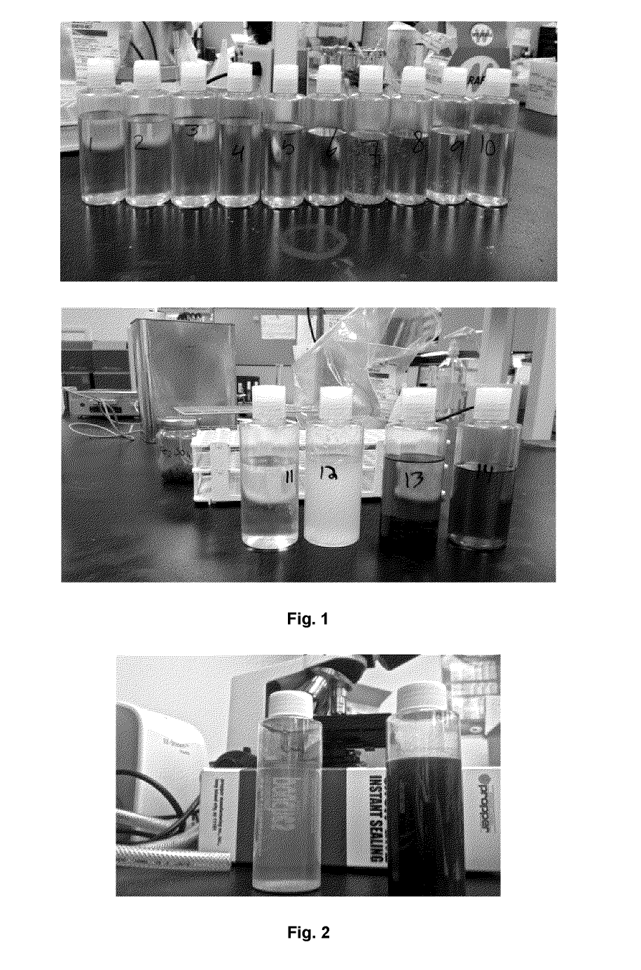

PH of all samples has been adjusted to 4. FIG. 1 shows pictures taken of all samples.

### Example II

### Solutions for the Remediation of Wastewater Derived from Vehicle Washing of Oil Sands Mining Operations

A water solution comprising 25% hydrogen peroxide and 2% sodium polyaspartate is prepared and pH is adjusted to 4 using hydrochloric acid, sulfuric acid or methanesulfonic acid.

Sanitisation of wastewater is achieved by the slow addition of this solution, preferably via a hose inserted below the surface of the water at a rate of 1000 to 5000 ppm. Solution will rapidly discolor and deodorise within hours and wastewater will clear if left to settle after 7 days.

Alternatively, a water solution containing 25% hydrogen peroxide and 20% polyethylene glycol and 5% calcium chloride is prepared and added to wastewater at a rate of 50 to 500 ppm. The solution is left to settle and separate for further processing.

### Example II

### Solutions for the Remediation of Wastewater Derived from the Cleanup Operations of Oil Spills

A water solution containing 25% hydrogen peroxide, 20% polyethylene glycol, or 2-4% sodium polyaspartate and 5-10% calcium chloride is added to the wastewater and left to settle and separate. Organic phase can be separated after 1 to 10 hours.

### Example III

### Solutions for the Remediation of Wastewater Derived from Cleanup Operations of Oil Spills Containing Significant Amounts of Sludge

A water solution containing 25% hydrogen peroxide and 4% sodium polyaspartate is prepared and pH adjusted to 4 using hydrochloric acid, sulfuric acid or methanesulfonic acid.

### Example IV

### Testing of Formulations in Clearing Sump Water

A solution of 5% polyaspartic acid and 24% of hydrogen peroxide as described herein was added at difference dosage to contaminated sump water.

TABLE 1
Sump water treated with 5% polyaspartic
acid and 24% of hydrogen peroxide

| | Transparency | | |
|---|---|---|---|
| Mixture | 1 (−) to 5 (+) | Elapsed Time | Microbiology |
| — | 1 | Duration of Test | Positive* |
| Dosage 1 | 5 | ≈24 Hours | Negative |
| Dosage 2 | 5 | ≈18 Hours | Negative |
| Dosage 3 | 4 | ≈12 Hours | Negative |
| Dosage 4 | 3 | ≈30 Minutes | Negative |
| Dosage 5 | 2 | ≈10 Minutes | Negative |

Based on the visual results and quantitative microbiology testing, the tested formulation clearly transformed sump water to transparent (see FIG. 2), odorless and bacteria free water via the infusion of environmentally responsible and economically viable liquid ingredients.

While the invention has been described in connection with specific embodiments thereof, it will be understood that it is capable of further modifications and this application is intended to cover any variations, uses, or adaptations of the invention following, and including such departures from the present disclosure as come within known or customary practice within the art to which the invention pertains and as may be applied within the scope of the appended claims.

What is claimed is:

1. A composition for remediation of wastewater comprising:
a water soluble sanitizer; and
a dispersing/emulsifier agent.

2. The composition of claim 1, wherein the water soluble sanitizer is an oxidizer.

3. The composition of claim 2, wherein the oxidizer comprises a fluorine, a hydroxyl radical, a sulfate radical, a persulfate anion, hydrogen peroxide, a permanganate, a peroxysulfuric acid, ozone, hypochlorite, chlorine dioxide, an organic peracid, a polymeric peracid, a polymeric peracid derived from polyaspartic acid or a combination thereof.

4. The composition of any one of claims 1-3, wherein the water soluble sanitizer is an organic peracid.

5. The composition of any one of claims 1-3, wherein the water soluble sanitizer is a polymeric peracid.

6. The composition of any one of claims 1-3, wherein the water soluble sanitizer is a polymeric peracid derived from polyaspartic acid.

7. The composition of any one of claims 1-6, wherein the water soluble sanitizer is hydrogen peroxide.

8. The composition of any one of claims 1-7, wherein the dispersing/emulsifier agent is polypropylene glycol, polyethylene glycol, polyaspartic acid, polyethylenimine, polyacrylic acid, or a combination thereof.

9. The composition of any one of claims 1-8, wherein said composition comprising between 2-70% of water soluble sanitizer and between 5-70% of dispersing/emulsifier agent.

10. A composition for remediation of wastewater comprising hydrogen peroxide and polyaspartic acid; hydrogen peroxide and polyacrylic acid; potassium permanganate and polyaspartic acid; or hydrogen peroxide and polyethylene glycol.

11. The composition of any one of claims 1-10, comprising 25% hydrogen peroxide and 2% polyaspartic acid, 25% hydrogen peroxide and 4% sodium polyaspartate; 25% hydrogen peroxide and 20% polyethylene glycol; 5% hydrogen peroxide and 2% polyaspartic acid; 20% hydrogen peroxide and 2% polyaspartic acid; 25% hydrogen peroxide and 0.5% polyaspartic acid; 25% hydrogen peroxide and 5% polyaspartic acid; 25% hydrogen peroxide and 10% polyaspartic acid; 25% hydrogen peroxide and 25% polyaspartic acid; 25% hydrogen peroxide and 50% polyaspartic acid; 30% hydrogen peroxide and 30% polyaspartic acid; 50% hydrogen peroxide and 30% polyaspartic acid; 70% hydrogen peroxide and 10% polyaspartic acid; 70% hydrogen peroxide and 10% polyacrylic acid; 70% hydrogen peroxide and 10% polyethylene glycol; 24% of hydrogen peroxide and 5% polyaspartic acid; or 70% permanganate and 10% polyacrylic acid.

12. The composition of any one of claims 1-11, wherein the dispersing/emulsifier agent has a suitable pH lower than 7.

13. The composition of any one of claims 1-12, wherein the pH of the dispersing/emulsifier agent is lower than 5.

14. The composition of any one of claims 1-13, wherein the pH of the dispersing/emulsifier agent is 4.

15. The composition of any one of claims 1-14, further comprising a settling and precipitation agent.

16. The composition of claim 15, wherein the settling and precipitation agent is calcium chloride, magnesium oxide or sodium chloride.

17. The composition of claim 15 or 16, wherein the settling and precipitation agent is calcium chloride.

18. The composition of claim 17, wherein said composition comprising at least 5% calcium chloride.

19. The composition of claim 17 or 18, wherein said composition comprising 10% calcium chloride.

20. The composition of any one of claims 1-19, wherein the wastewater comprises organic molecules, sulfur containing molecules, solid matter, metals, pathogenic bacterial contaminants, or a combination thereof.

21. The composition of claim 20, wherein the organic molecules are alkanes, paraffin, kerosene, olefins, naphthalene, xylene and aromatics molecules.

22. The composition of claim 21, wherein the sulfur containing molecules are hydrogen sulfide.

23. The composition of claim 20, wherein the solid matter is sand, clay, or a combination thereof.

24. The composition of claim 20, wherein the metals are nickel or vanadium.

25. The composition of claim 20, wherein the pathogenic bacterial contaminants are E. coli bacteria.

26. A method for remediation of wastewater of contaminants comprising the step of adding a composition comprising a water soluble sanitizer and a dispersing/emulsifier agent to the wastewater to be remediated, producing a remediated water removed of contaminants.

27. The method of claim 26, wherein the water soluble sanitizer is an oxidizer.

28. The method of claim 27, wherein the oxidizer comprises a fluorine, a hydroxyl radical, a sulfate radical, a persulfate anion, hydrogen peroxide, a permanganate, a peroxysulfuric acid, ozone, hypochlorite, chlorine dioxide, an organic peracid, a polymeric peracid, a polymeric peracid derived from polyaspartic acid or a combination thereof.

29. The method of any one of claims 26-28, wherein the water soluble sanitizer is an organic peracid.

30. The method of any one of claims 26-28, wherein the water soluble sanitizer is a polymeric peracid.

31. The method of any one of claims 26-28, wherein the water soluble sanitizer is a polymeric peracid derived from polyaspartic acid.

32. The method of any one of claims 26-31, wherein the water soluble sanitizer is hydrogen peroxide.

33. The method of any one of claims 26-32, wherein the dispersing/emulsifier agent is polypropylene glycol, polyethylene glycol, polyaspartic acid, polyethylenimine, polyacrylic acid, or a combination thereof.

34. The method of any one of claims 26-33, wherein said composition comprising between 2-70% of water soluble sanitizer and between 5-70% of dispersing/emulsifier agent.

35. The method of any one of claims 26-34, wherein said composition comprising hydrogen peroxide and polyaspartic acid; hydrogen peroxide and polyacrylic acid; potassium permanganate and polyaspartic acid; or hydrogen peroxide and polyethylene glycol.

36. The method of any one of claims 26-35, wherein said composition comprising 25% hydrogen peroxide and 2% polyaspartic acid, 25% hydrogen peroxide and 4% sodium polyaspartate; 25% hydrogen peroxide and 20% polyethylene glycol; 5% hydrogen peroxide and 2% polyaspartic acid; 20% hydrogen peroxide and 2% polyaspartic acid; 25% hydrogen peroxide and 0.5% polyaspartic acid; 25% hydrogen peroxide and 5% polyaspartic acid; 25% hydrogen peroxide and 10% polyaspartic acid; 25% hydrogen peroxide and 25% polyaspartic acid; 25% hydrogen peroxide and 50% polyaspartic acid; 30% hydrogen peroxide and 30% polyaspartic acid; 50% hydrogen peroxide and 30% polyaspartic acid; 70% hydrogen peroxide and 10% polyaspartic acid; 70% hydrogen peroxide and 10% polyacrylic acid; 70% hydrogen peroxide and 10% polyethylene glycol; 24% of hydrogen peroxide and 5% polyaspartic acid; or 70% permanganate and 10% polyacrylic acid.

37. The method of any one of claims 26-36, wherein the dispersing/emulsifier agent has a suitable pH lower than 7.

38. The method of any one of claims 26-37, wherein the pH of the dispersing/emulsifier agent is lower than 5.

39. The method of any one of claims 26-38, wherein the pH of the dispersing/emulsifier agent is 4.

40. The method of any one of claims 26-39, wherein said composition further comprises a settling and precipitation agent.

41. The method of claim 40, wherein the settling and precipitation agent is calcium chloride, magnesium oxide or sodium chloride.

42. The method of claim 40 or 41, wherein the settling and precipitation agent is calcium chloride.

43. The method of claim 42, wherein said composition comprising at least 5% calcium chloride.

44. The method of claim 42 or 43, wherein said composition comprising 10% calcium chloride.

45. The method of any one of claims 26-44, wherein the wastewater comprises organic molecules, sulfur containing molecules, solid matter, metals, pathogenic bacterial contaminants, or a combination thereof.

46. The method of claim 45, wherein the organic molecules are alkanes, paraffin, kerosene, olefins, naphthalene, xylene and aromatics molecules.

47. The method of claim 45, wherein the sulfur containing molecules are hydrogen sulfide.

48. The method of claim 45, wherein the solid matter is sand, clay, or a combination thereof.

49. The method of claim 45, wherein the metals are nickel or vanadium.

50. The method of claim 45, wherein the pathogenic bacterial contaminants are E. coli bacteria.

51. A method of manufacturing the composition for remediation of wastewater of any one of claims 1-25 comprising mixing the water soluble sanitizer and the dispersing/emulsifier agent.
